(19) United States
(12) Patent Application Publication
(10) Pub. No.: US 2005/0068322 A1
(43) Pub. Date: Mar. 31, 2005

(54) Generating alphanumeric characters

(76) Inventor: Richard A. Falcioni, Sylmar, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/674,443

(22) Filed: Sep. 29, 2003

(51) Int. Cl. G06T 11/00

(52) U.S. Cl. 345/467

(57) ABSTRACT

In some embodiments of the invention a desired alphanumeric character is generated through the use of mnemonic aids which are provided to represent the alphanumeric characters. Each aid is designed so that it can suggest to a person a respective combination of one or more zones to be selected from a number of zones. The respective combination is such that if contrasted with the remainder of the zones, or with the remainder of an area that is coextensive with and contains all of the zones, the remainder resembles the desired character. Other embodiments are also described and claimed.

### BACKGROUND

An embodiment of the invention described below relates to a technique for representing alphanumeric characters (such as the letters of the English alphabet) using a set of graphic symbols that may have reduced information content relative to the characters. In addition to other applications, the technique may allow fast and accurate direct manual entry of electronic data into a device that has limited physical space for data entry, such as a personal digital assistant (PDA) with a touch-sensitive display screen. Other embodiments of the invention are also described.

Small, electronic logic-controlled devices such as PDAs are popular tools for taking notes and communicating with others. They are battery-powered and portable yet can deliver significant computing power and connectivity. Their small size however may preclude a full-size keyboard in which each letter of the alphabet is assigned a large, separate key. Instead, these devices typically have a specialized data input interface, such as a touch-sensitive display screen, with a relatively small area on which an operator draws, using a hand-held stylus, the character that he wants to enter. After the operator makes the drawing on the interface, the device then attempts to interpret the drawing to determine the intended character. Words and phrases can be entered in this manner, without using a full keyboard, provided the device can properly interpret the operator's handwriting. To assist in this process, restrictions are placed on the location in the writing area and the path to take when the user makes a drawing. An example of such a device is the PALM handheld computing device that features the GRAFFITI writing software, by Palm, Inc., Milpitas, Calif.

Although the suggested GRAFFITI drawings bear a strong resemblance to their corresponding characters, the technique often results in the wrong character being detected when the pace of writing quickens. In addition, there is a noticeable delay between the point in time that the user has completed a drawing and when the corresponding character appears before the user.

Another method for entering alphanumeric data is described in U.S. Pat. No. 5,982,303 to Smith. That patent describes how a complete set of alphanumeric characters may be entered on a data input device having only nine keys arranged in an array. Each character is input by entering sequential keystrokes which define a pictograph. The patent also alleges that an untrained operator can quickly learn the pictographs which correspond to each character. While some of the pictographs employed bear a vague resemblance to their corresponding alphanumeric characters, most do not. As a result, the operator may be required to spend a significant period of time learning or memorizing the strokes needed to enter most of the characters.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 illustrates a table of a set of character features or building blocks that are in the nature of open and closed plane curves, and how each character can be decomposed into a subset of these curves.

FIG. 2, shows a tentative matrix obtained by assembling the features together based on their relative positions.

FIG. 3 illustrates application of the stretched matrix to select a combination of features that represent the letter “b”.

FIG. 4 depicts a complement matrix.

FIG. 5 shows regions of a solid, complement matrix being visually contrasted with the remainder of the matrix to form a graphic symbol for the letter “b”.

FIG. 6 shows examples of how the matrix-complement approach may be used for forming more complex graphic symbols than necessary, to obtain a more recognizable graphic symbol.

FIG. 7 illustrates a set of recognizable graphic symbols that correspond to the 26 letters of the English alphabet and the 10 decimal system numerals, based on a 19-element matrix-complement approach.

FIG. 8A shows how the 19-element complement matrix is overlayed by a 12-element (three column by four row) control matrix.

FIG. 8B depicts a six-point array that can be used instead of a grid, to suggest the fixed locations of the regions of a 12-region control matrix.

FIG. 9 illustrates 36 code configurations of the 19-zone complement matrix overlayed with the 12-zone control matrix, highlighting selections of no more than two control zones in each code configuration.

FIG. 10A shows 36 graphic symbols all using the 12-zone control matrix with no more than two zones in each selection, yet still being readily recognizable as the characters they are intended to represent.

FIG. 10B depicts a stylized glyph pictogram that is aligned with its corresponding control regions.

FIG. 11A symbolizes an example process of construction, in the mind of a user, for indicating the letter “K”.

FIG. 11B shows in block diagram form a handheld computing device.

FIG. 11C depicts in block diagram form a handheld computing device in which the input control and visualization areas overlap a large portion of the character output display.

FIG. 12A depicts pen-down and pen-up actions by a user, on a touch-sensitive screen, for selecting the regions or zones of a matrix.

FIGS. 12B-E illustrate the use of a swirl action on a touch-sensitive screen, for differentiating between characters that share one or more control regions or code configuration.

FIG. 13A illustrates another set of graphic symbols that recognizably represent the 36 alphanumeric characters, while adhering to the matrix complement concept.

FIG. 13B depicts a generic receiving area template for illustrating the symbols of FIG. 13A.

FIG. 14 shows a word formed as a combination of symbols taken from those in FIG. 13A.

### DETAILED DESCRIPTION

An embodiment of the invention is directed to a character representation technique in which each alphanumeric character is represented by a separate, graphic symbol that is designed to be a mnemonic aid to the user. The user, when looking at the graphic symbol, should be able to easily determine or recall which character corresponds to the symbol. In addition, each graphic symbol is easy to remember, because it is designed in such a way as to be suggested by one or more apparent, basic features of its respective alphanumeric character.

For the user to indicate her desired character, a group of zones may be defined in a writing area or receiving area. Each symbol is designed to suggest to or remind the user of a respective combination of one or more zones, to be selected from the group. The combination of zones for a desired character is defined so that, when visually contrasted with the remainder of the group, the remainder of the group resembles the desired character. Each zone of a given combination may serve to highlight or suggest one or more respective features of the corresponding character, via a complementary rather than direct relationship with that feature. In the following section, a derivation for a set of basic features or building blocks is given, by decomposing each character into one or more of these basic features.

The character representation technique has been applied to decompose each of the twenty-six letters of the English alphabet and ten decimal numerals, into just a few features taken from a set of nineteen (19) features. This so-called feature-based representation of each character may be used as the graphic symbol for that character. This type of symbol is preferably depicted using a matrix of twelve zones, arranged in four rows and three columns. A motivation for this particular number and arrangement of zones is given below, although it is possible to use other zone arrangements, as well as a different number of zones, for indicating the symbols. For example, a 19-zone matrix (that is a direct result of the 19 basic features) may be used by itself, i.e. without reduction to the 12-zone matrix, to depict the graphic symbols. It has also been found that every one of the alphanumeric characters may be represented by a respective combination of no more than two zones (even in the 12-zone matrix). This combination is also referred to as a code configuration.

Due to the relative simplicity of each combination of zones, a user can quickly indicate her desired character by making merely one or two selections on the matrix. Users can be expected to rapidly learn the combination for entering a character, because each combination is easily distinguishable from another and is naturally suggested by the basic features of its respective character. Accordingly, this is expected to allow the user to form entire words and phrases quickly and in a relatively error-free manner. Each indicated combination can be mapped into its corresponding character through a look-up table, thereby allowing low-cost yet fast, electronic decoding of the combinations. This renders the technique particularly effective for data entry in small, electronic logic-controlled devices that do not have a full-size keyboard, although other applications such as paper forms (to be filled in by hand and then scanned electronically) may also benefit from the technique.

A derivation of the preferred mapping between each combination of one or more zones and its corresponding alphanumeric character may be summarized as follows. First, each character is represented as a juxtaposition of some of a set of open and closed plane curves, also referred to as features or components. These features are like building blocks and may be idealized into rectangles or squares, and angular portions of such rectangles or squares. Other shapes are, however, possible. As explained in detail below, there may be 19 different features needed to compose all of the letters of, for example, the English alphabet and the 10 decimal numerals. Next, a template or matrix is created based on the entire set of features, by abutting the features to each other in such a way that each feature can be visually distinguished from the others. This template may then be overlayed with a smaller, second matrix (e.g. a 12-zone matrix). The second matrix acts as an adapter, to further reduce the number of control regions that will be offered to the user for indicating a character, from 19 to, in this example, just 12. Each character is indicated by a respective selection of one or more (and in most cases, no more than two) regions or zones in a matrix.

Feature-Based Character Decomposition

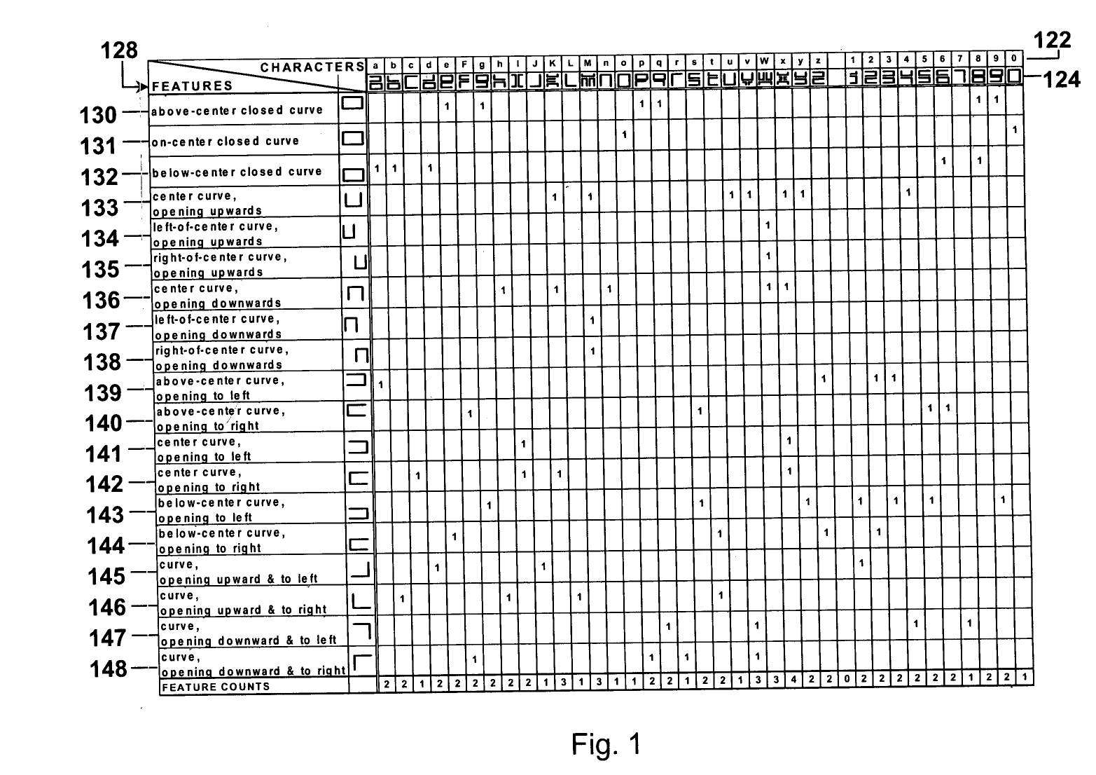

FIG. 1 illustrates a table of a set of character features or building blocks in the nature of open and closed curves. The inventor has found that a complete set of distinct, graphic symbols may be generated, from such a relatively small set of features or building blocks that closely resemble their respective characters. The features are shown in the rows of the table of FIG. 1. A set of 36 alphanumeric characters including the letters of the English alphabet (some in lower case while others in upper case) and the ten decimal numerals are listed in a first upper row 122.

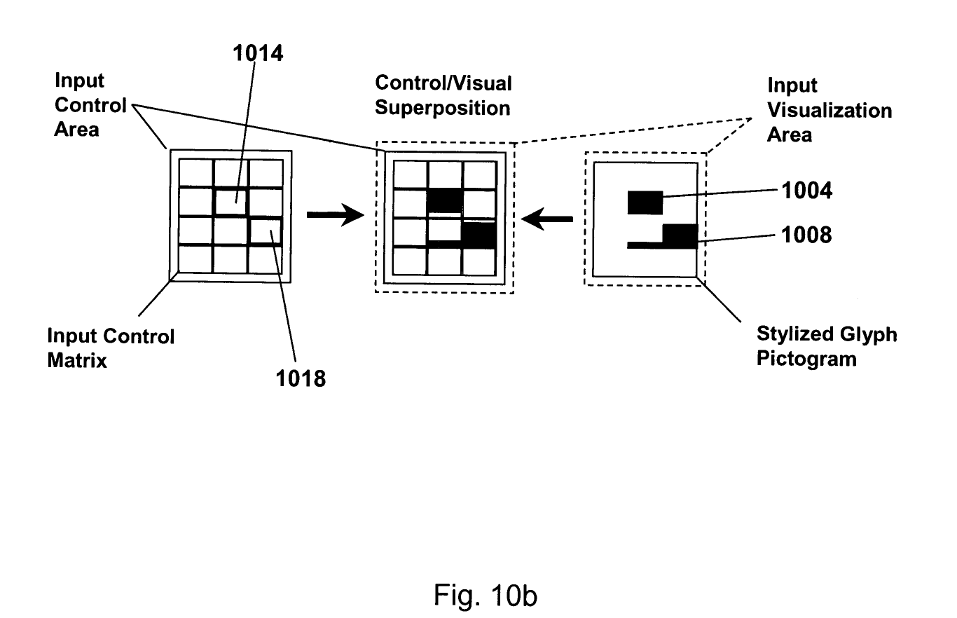

Within the column beneath each character in the first upper row 122 are marked the features, taken from a left hand column 128, that may be deemed necessary and, in most cases, sufficient for recognition purposes. For example, the letter “o” has only a single mark in its column, in the row associated with what is referred to as the on-center, closed curve 131. In a second upper row 124 are all of the corresponding graphic symbols that are composed from the features. The sufficiency or near sufficiency of just those features for recognition purposes can be appreciated. In some cases, slightly different features may be used, or feature nuances may be added, for characters that look similar. For example, “o” and “0” may be represented by an on-center closed curve 131 and a below-center closed curve 132, respectively. In the case of “s” and “5”, and “z” and “2”, feature nuances may be defined as illustrated in FIG. 9 to distinguish their selection processes. Note that feature nuances, employing fragments of a feature, may also be used simply to make a graphic symbol more recognizable.

The features listed in the left hand column 128 may be grouped into three distinct categories, namely (1) closed plane curves, (2) unshaped plane curves that open up, down, left and right, and (3) right angle shaped plane curves that open out to the four quadrants (upper-left, upper-right, lower-right and upper-left). In such idealized form, as rectangles or parts of rectangles, the curves in these three categories are angular; alternatively, they may be defined using smoother, less angular curves or shapes.

Note that each feature may be defined not only by its shape and orientation, but also by a relative location. The inventor has found that these 19 features may be sufficient to generate the readily recognizable set of 36 graphic symbols, corresponding to the 36 alphanumeric characters set forth in the first row 122 of the table in FIG. 1. Note also that 33 out of the 36 can be characterized with at most two features. And of those 33, 25 of them can be characterized uniquely so that they can be distinguished from the others on the basis of feature decomposition alone. This character representation technique can also be referred to as a modular character construction methodology, where each character can be decomposed into one or more modules. It should be noted that the characters may alternatively be represented by combinations of features other than those listed in FIG. 1. Also, a different set of constituent features may be defined, that may be more or less numerous than the 19 shown in FIG. 1 and that may have different shapes and orientations.

When decomposing the characters into their constituent features, each character is preferably drawn to fill the same vertical range. Terms like upper or lower (or above-center and below-center) can therefore be interpreted as situating a feature in the upper or lower half of that vertical range.

The features that are indicated in FIG. 1 as constituting each symbol may be viewed as meeting a minimum threshold needed to make a character representation recognizable and distinguishable from the other characters. Indeed, a graphic symbol may be defined in a more complex manner, using additional features or nuances. For example, when using only the given set of features shown in FIG. 1, some characters may not be readily distinguishable from others, such as “g” and “9”, “o” and “0”, “s” and “5” and “z” and “2”. In addition, to make the letter “v” more recognizable and also distinguishable from the letter “u”, “v” may be represented as if it were an upper case “Y” with a very short stem. This provides the effect of the characteristic “v” vertex, thus distinguishing it from the rounder or flatter “^{u”}. Other enhancements to make a symbol more recognizable are possible. Some special cases will be addressed below.

The Matrix-Complement Approach

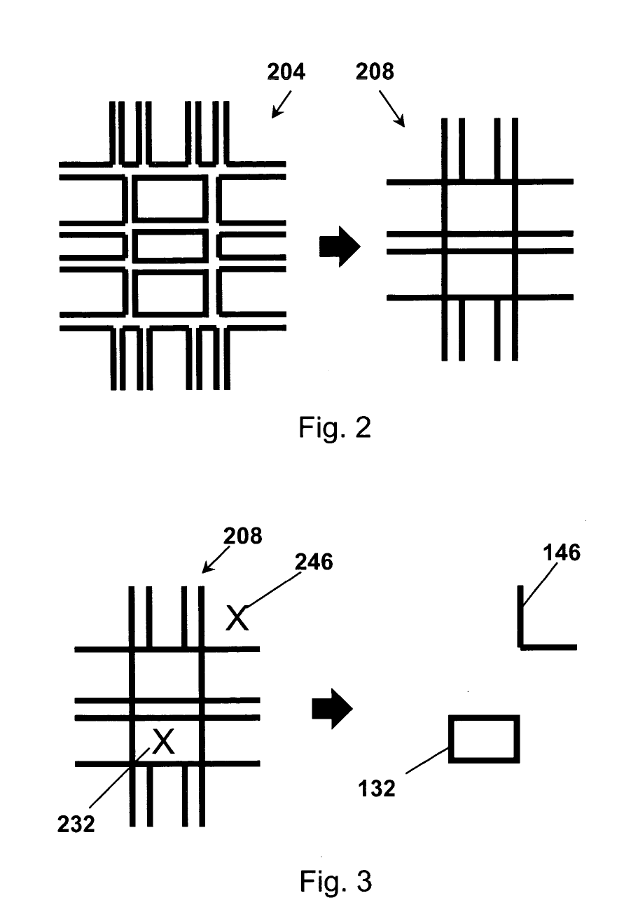

In addition to discovering that the characters can be decomposed into constituent features, the inventor has also found an effective process for indicating the graphic symbol (and hence the desired character) by a user. First, a template 204 is formed, as shown in FIG. 2, by bringing the features close together based on their relative positions (that is upper, center, lower), and their orientation (that is opening to the right, opening to the left, opening upward and to the left, etc.) Features that have an orientation associated with them are located at the outside of the matrix, where the feature can face out in its specified direction.

Next, almost all of the assembled features are “stretched” so that they abut one another, eliminating the intervening spaces and thereby resulting in a stretched matrix 208 in FIG. 2. Note also that the stretched features become the boundaries of the regions in the matrix 208 in such a way that most of the regions line up in rows and columns. The purpose for this will become apparent below.

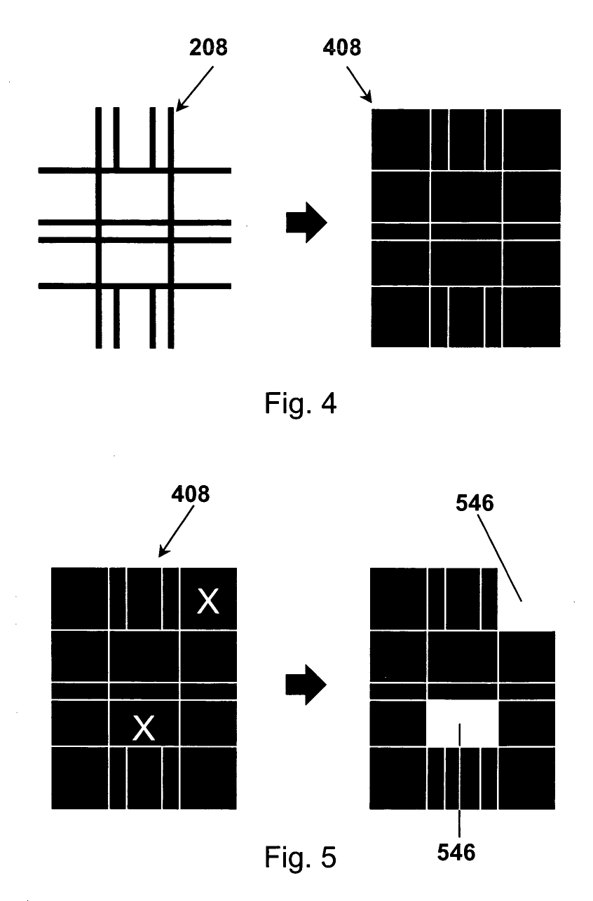

FIG. 3 illustrates application of the stretched matrix 208 to select a combination of features that represent the letter “b”, namely the below-center closed curve 132 and the curve opening upward and to the right 146 (see also FIG. 1). Note how the features 132, 146 may be selected by the user's manual actions (indicated by the X) upon the corresponding regions (or elements) 232 and 246 of the matrix 208. However, the features, as highlighted in the right-hand diagram of FIG. 3, may not easily convey the form of a recognizable character.

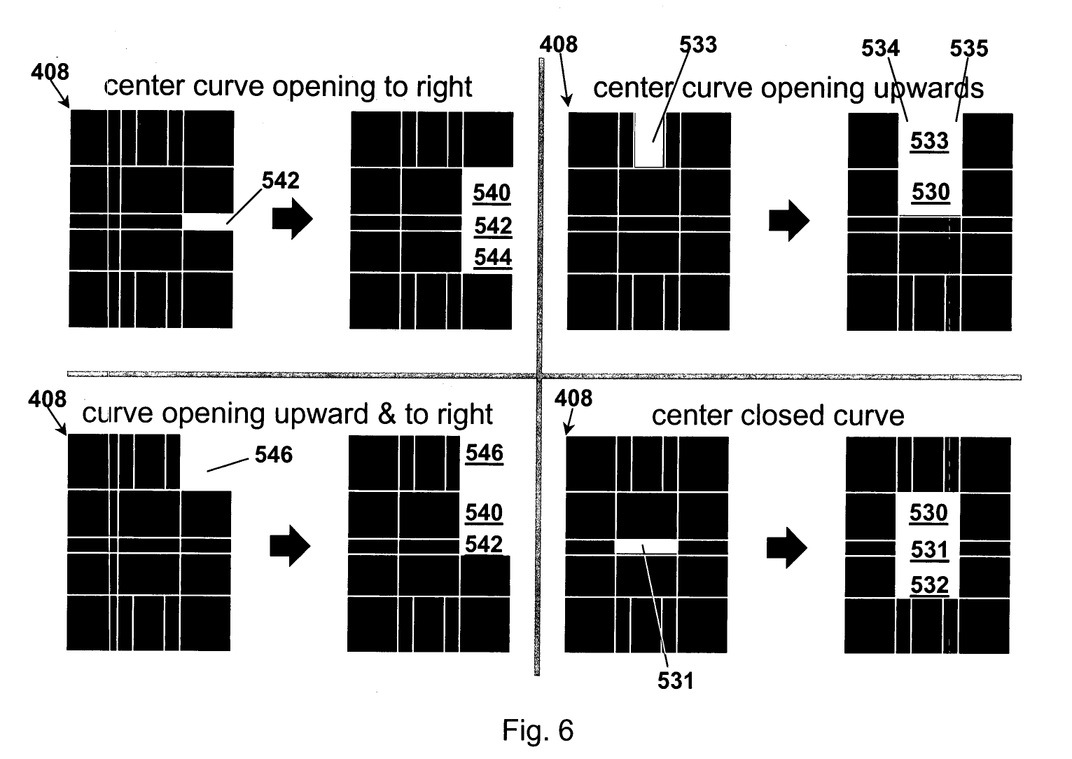

A solution to the above difficulty may be to first provide a rectangular background to the matrix 208, and second, interpret the features as though they partition the background into smaller parts or components. This combination of a rectangular background (having preferably a solid color) that is partitioned into regions or zones, which are delineated in part by basic features of a set of alphanumeric characters, is referred to as a complement matrix 408, depicted in the right-hand diagram of FIG. 4. The reason for using the term “complement” will become clear below.

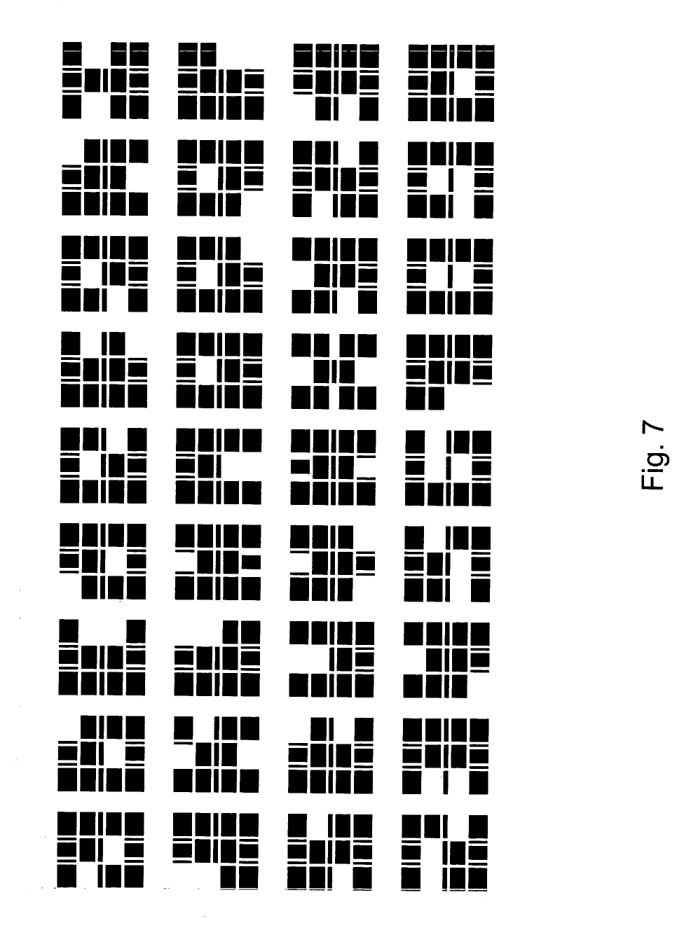

Next, it is instructive to note what happens when, for example, regions 532 and 546 in the solid, complement matrix 408 are visually contrasted with the remainder of the matrix, as shown in FIG. 5. A graphic symbol is formed that bears a strong resemblance to the letter “b”. This resemblance may become more apparent when the symbol is viewed from a further distance. This character representation is advantageously achieved without having to juxtaposition the features 132 and 146, as would be needed in FIG. 3 to recognize that the letter “b” is being sought. The regions 532 and 546 of the matrix 408 are said to suggest the features 132 and 146 (see FIG. 3), through a complementary rather than direct relationship with those features.

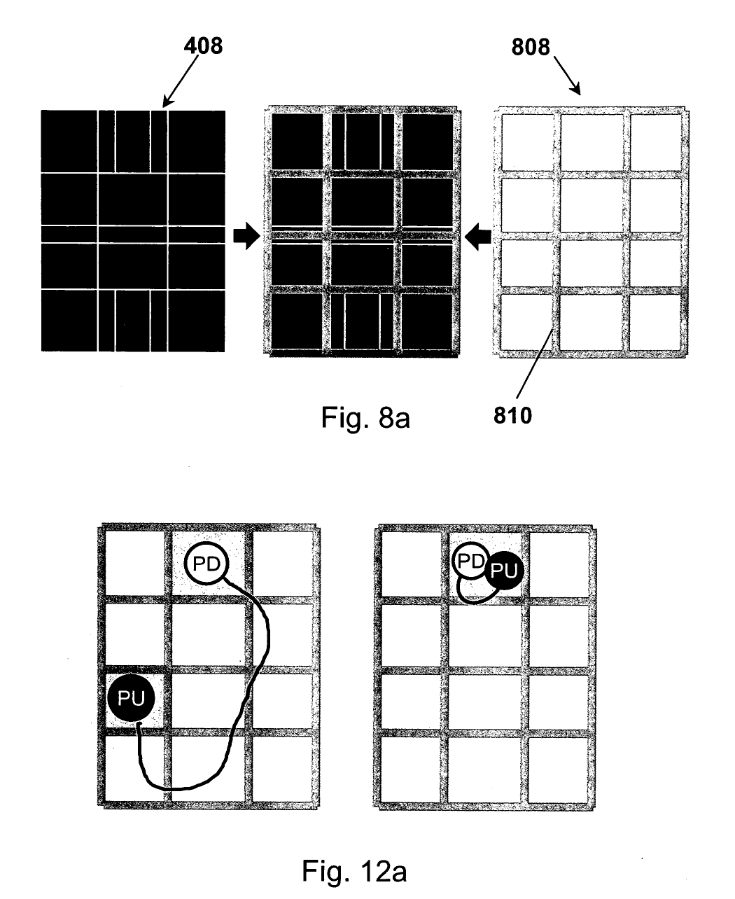

It should also be noted that the complement matrix 408 allows a feature of a character to be represented in more than one way. For example, consider FIG. 6 where the feature of a center curve opening to the right (reference no. 142 in FIG. 1) can be recognizably represented by contrasting region 542 with the remainder of the matrix 408. An alternative here is to visually contrast the three regions 542, 540, and 544. The latter combination of regions might yield a more recognizable graphic symbol (in this case representing the letter “c”). FIG. 6 also shows other examples of the matrix-complement approach for forming more complex graphic symbols than necessary, i.e. the letter “u” (center curve opening upwards 133 suggested by the complement region 533), the letter “L” whose graphic symbol is formed by visually contrasting the complement region 546, and finally the letter “o” whose graphic symbol is formed by visually contrasting the region 531.

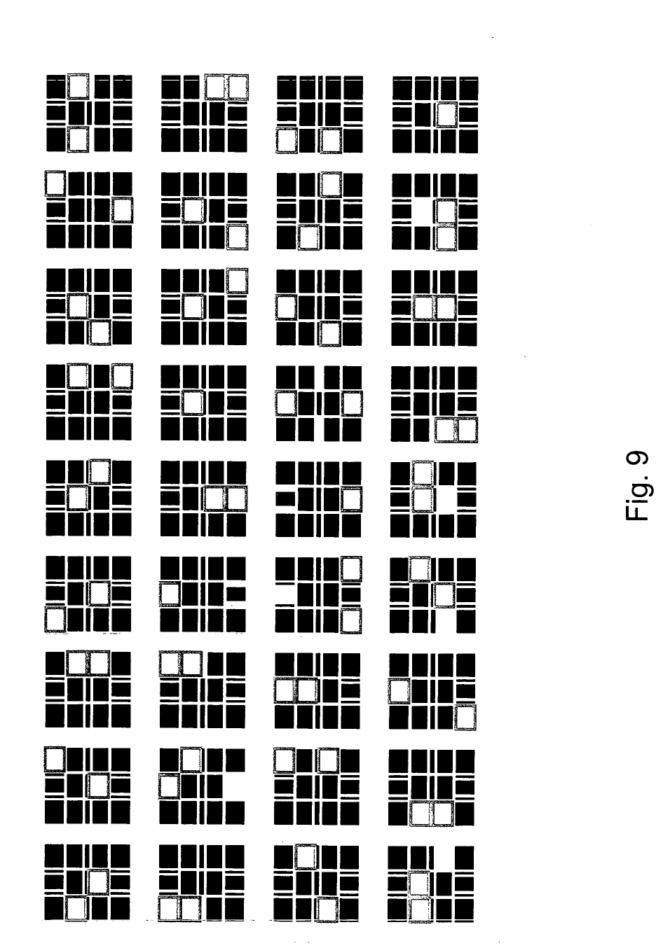

Using the matrix complement technique described above, and sometimes applying multiple compliment regions per feature, a set of recognizable graphic symbols may be generated that correspond to the 26 letters of the English alphabet and the 10 decimal system numerals as shown in FIG. 7. The graphic symbols are easily recognized to be the characters they are intended to represent.

Another way to understand the matrix-complement approach may be as follows. Rather than being directed to a drawing-based approach where the features of a character, or even a mnemonic, are positively recited by the application of force (via a finger or stylus) on a receiving area, an embodiment of the invention instead indicates each character starting with a matrix of solid elements that are of the same color or material, from which pieces are essentially “removed” by the user applying force to those pieces, when entering her desired character. This leaves behind a graphic symbol (also referred to as a stylized, glyph or glyph-like pictogram) that closely resembles the character. Thus, it is the remainder of the matrix, or the remainder of the group of regions that make up the matrix, which resembles the character, once the selected regions have been removed or visually contrasted in response to user input.

The Control Matrix

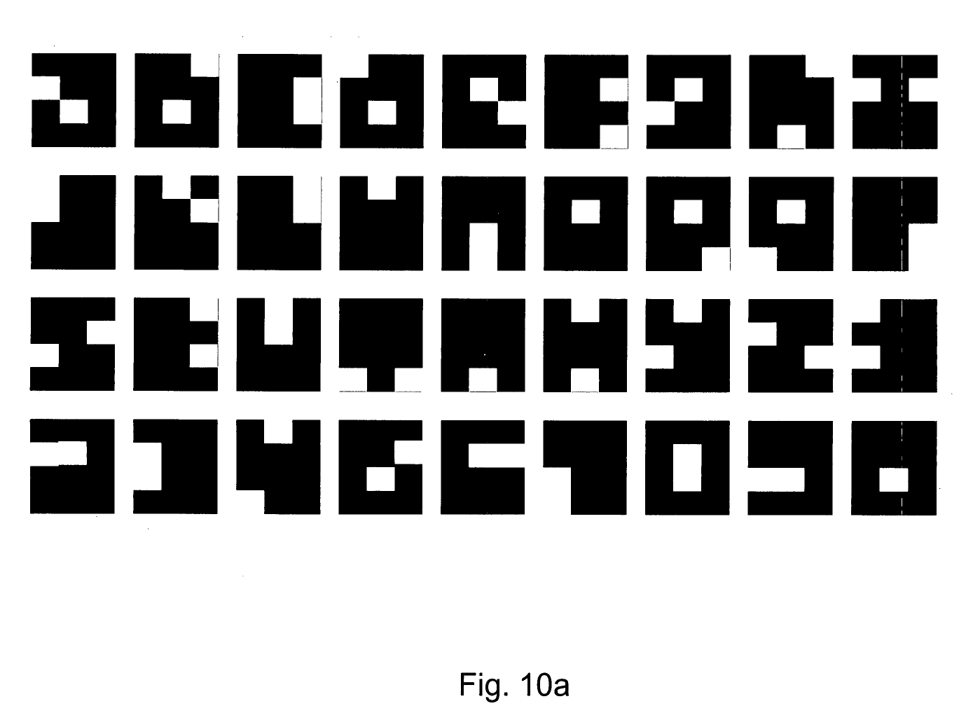

Although in the complement matrix 408 not all rows have the same number of regions, it is possible to overlay a three column by four row array of rectangular regions or zones over the complement matrix 408. In that case, each of the larger elements of the complement matrix 408 may be completely contained in a separate one of the twelve regions. This is illustrated in FIG. 8A where the complement matrix 408 is overlayed by a three column by four row control matrix 808.

The control matrix 808 is intended to be a more efficient means for the user to enter manual actions that indicate a desired character, by the selection of one or more of twelve zones that overlay the elements of the complement matrix 408. Note that the selection zones in the control matrix 808 are fewer and larger than those of the complement matrix 408 and accordingly should be easier for the user to operate.

To suggest in the mind of the user the fixed locations of the control regions in the control matrix 808, a grid 810 may be displayed. As an alternative to the grid, a six-point array 814 with a visible outside boundary 816 may be displayed, as shown in FIG. 8B.

Mnemonic aids

In a preferred embodiment, at most two selection zones are needed to identify any one of the 36 alphanumeric characters previously mentioned. This embodiment is illustrated in the 36 configurations of FIG. 9 where each combines an instance of the 19-zone complement matrix overlayed with the 12-zone control matrix. These regions or zones may correspond to push-buttons on a keyboard or keypad, or to highlighted areas on a touch sensitive surface.

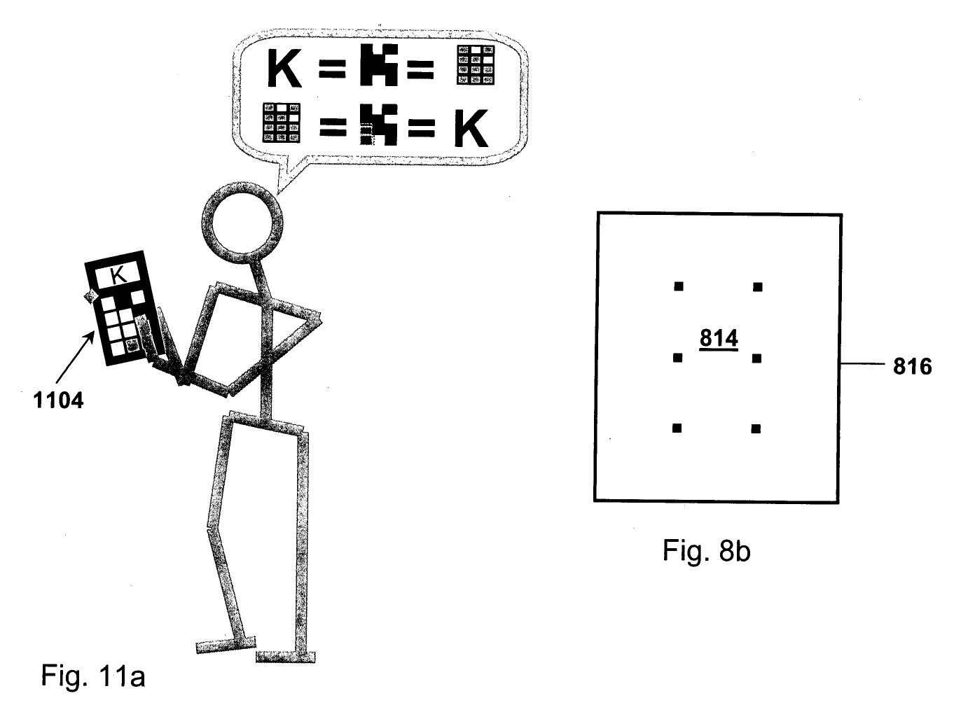

The 36 configurations shown in FIG. 9 may also be used as the graphic symbols or mnemonic aids. As an alternative, an otherwise solid 12-zone matrix depicting a respective 2-zone selection for a given character may be used as the graphic symbol for that character. That is because despite having less detail than those based on the 19-zone matrix, graphic symbols that use the 12-zone matrix are still recognizable as the characters they are intended to represent. See, for example, the two-zone representation of each graphic symbol depicted in FIG. 10A. Note that the outline or border of each instance of the 12-zone matrix does not appear in that it is of the same color as the background around each matrix.

As another alternative, a more detailed graphic symbol may be provided to represent a character and to act as the mnemonic aid. More detailed graphic symbols may be used to represent special characters other than those of the alphabet. For example, additional detail may be provided for the graphic symbols that represent the characters “[”, “{”, and “C” (upper case c), to clearly distinguish the symbol used for the letter “c”. The graphic symbols depicted in FIG. 9 are preferred, because each of them readily maps into and is identified with the regions or zones for their selection. It is believed that this aspect makes it relatively easy for people to remember how to designate a desired character, in the feature-based, complement matrix approach.

In the preferred embodiment, a graphic symbol (e.g. a stylized glyph pictogram) is made to appear, when the user has selected a given combination of regions from the control matrix that correspond to that symbol. In addition, this symbol is preferably “aligned” with its corresponding control regions. In other words, at least a part of every contrast area (that allows the symbol to be viewed) falls within the corresponding control region that has been selected. For example, in FIG. 10B, at least a part of the area 1004 falls within the selected control region 1014. Similarly, at least a part of the area 1008 falls within the selected control region 1018.

The preferred relationship between a stylized glyph, as it appears before the user, and its corresponding, selected control regions may also be explained as follows. First, the stylized glyph should be comparable in size to the entire control matrix. Second, the outside boundary of the stylized glyph should be substantially co-extensive with that of the control matrix. Both of these conditions can be seen in the control/visual superposition diagram that depicts the letter “e” in FIG. 10B. This alignment reinforces, in the user's mind, the mapping between the control regions to be selected and the corresponding alphanumeric character. First, it does not introduce distractions and keeps the user focused on the task at hand (namely, indicating a desired character). Second, showing the stylized glyph so aligned is expected to help meet the user's expectations of her desired character being invoked. This may be particularly helpful when a character input panel before the user appears as a solid rectangle, with no outline that shows the boundaries of the control regions.

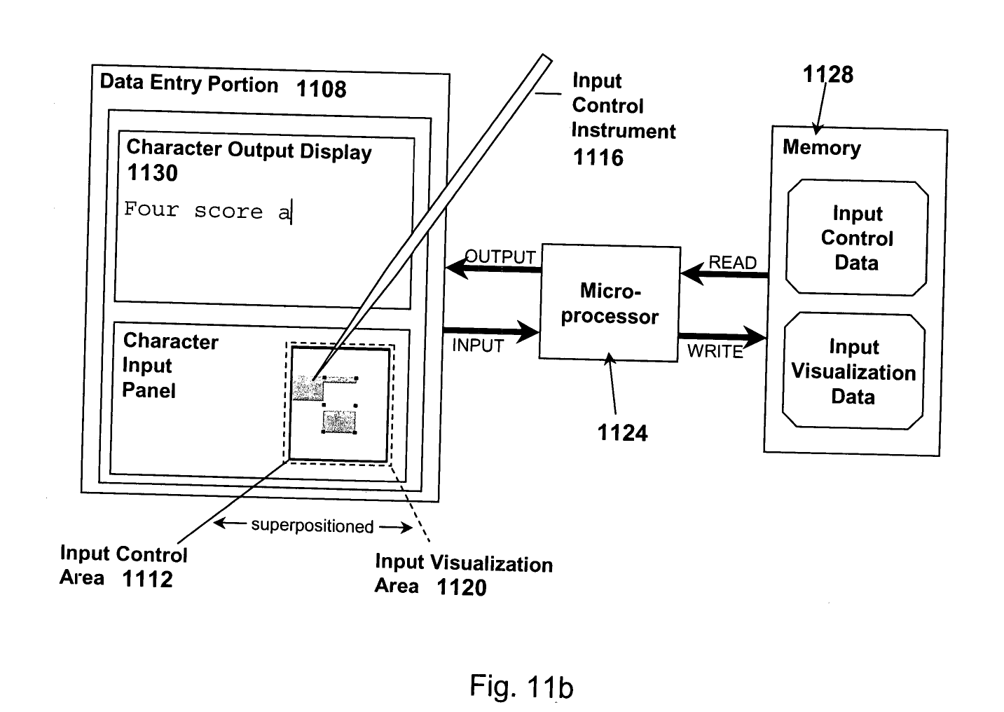

A process for constructing a desired character may be described as follows. First, when the user wants to generate a particular character, he or she recalls the corresponding, graphic symbol, as shown for example in FIG. 7. This graphic symbol then in turn suggests the regions or zones to be selected, namely those highlighted in FIG. 7 or depicted in white in FIG. 1A. This forward process of construction in the mind of the user is symbolized in FIG. 11A for the example letter “K”. However, the reverse is also true. When the user has selected the correct zone combination, the remainder of the selection area or matrix will look like the desired character, thus confirming for the user that he or she has selected correctly.

System Applications

FIG. 11A also depicts a user operating a handheld computing device 1104, such as a PDA device. As shown in block diagram form in FIG. 11B, the handheld device 1104 includes a data entry portion 1108 such as a touch-sensitive display screen in which a matrix of control regions have been defined in a preferably flat, input control area 1112. Each of the control regions is sensitive to a force exerted by the user via his or her finger or via an input control instrument 1116 such as a stylus. In addition, the input control area 1112 may be superimposed with an input visualization area 1120 (or vice versa), so that each of the control regions can be visually contrasted with the remainder of the matrix when the user has selected the region. The visualization area 1120 also allows a graphic symbol, bearing either the 19 zone matrix 408 (see FIGS. 4-7), a 12 zone matrix 808 (see FIG. 8 and FIG. 1A), or another higher or lower resolution alternative, to be depicted when the control regions are selected by the user. Some type of portable power source, such as a rechargeable battery or a fuel cell (not shown) is provided in the PDA device, coupled to power the display screen as well as the logic which implements the character representation technique described above.

FIG. 11B also shows a separate character output display 1130, used for displaying the generated characters, either in the form of their respective graphic symbols or in a conventional, high resolution font. An alternative to this arrangement is to locate the input control area 1112 and the input visualization area 1120 so as to partially or even completely overlap with a part of the larger, character output display 1130 (see FIG. 11C where the input control and visualization areas 1112, 1120 (superimposed relative to each other) overlay a large portion of the output display 1130 where previously generated words and characters are simultaneously being displayed); this alternative may be especially useful for very small devices 1104 such as enhanced watches where display area is at a premium.

The device 1104 should preferably include further logic that is designed to control the touch sensitive display screen so that each respective combination of zones selected by the user is visually contrasted with the remainder of the matrix, as the operator selects the combination. This produces in effect a real-time sensation in the operator of drawing the desired character. Of course, as explained above, the operator does not actually draw a character in the matrix complement technique, but rather assembles it using the feature-based, complementary approach described above. It should be noted that the logic circuitry may include hardwired logic circuitry and/or a programmed processor device having a machine-readable medium (such as random access memory 1128) with input control data and input visualization data stored therein that, when accessed by a microprocessor 1124, performs the matrix-complement approach described above using, for example, a table look-up to match a given input combination of control regions with a corresponding character and its graphic symbol.

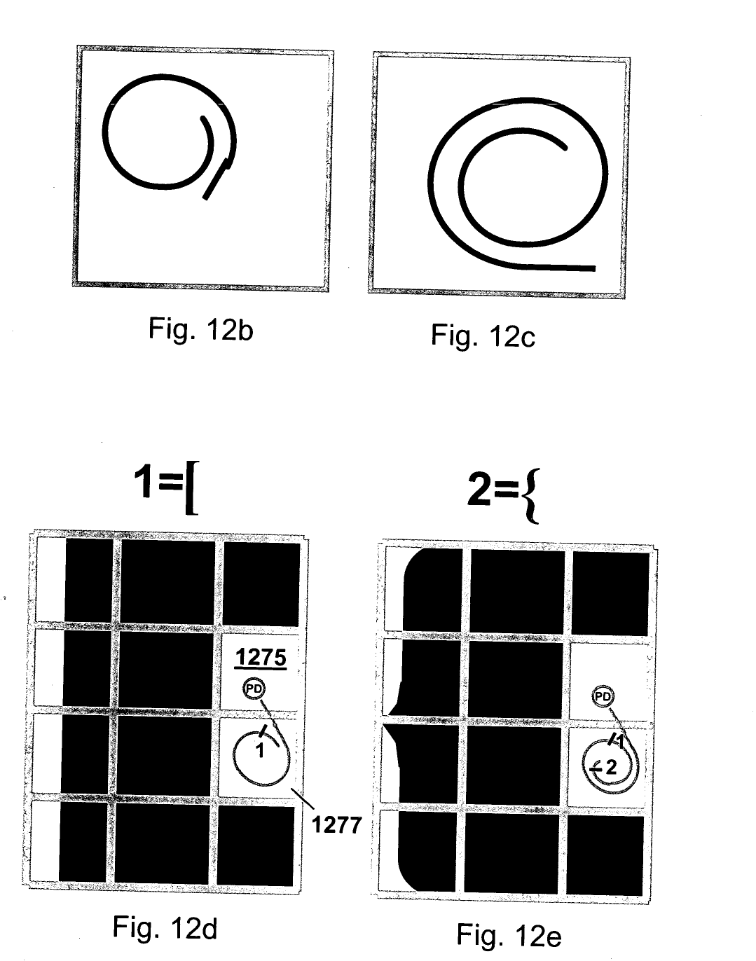

Although the matrix-complement character generation concept described above can be applied in electronic systems having mechanical or virtual buttons as the selection controls, the preferred embodiment is implemented in touch-sensitive screen systems that also support touch-begin and touch-end (or also referred to as pen-down, PD, and pen-up, PU) events. Using such a technique, it has been found that each character can be identified by a single stroke of the pen or stylus on the touch sensitive screen. More specifically, the first region or zone is selected with a pen-down action, as shown in FIG. 12A for the 12-zone matrix. The second, and in this case the last, region is selected by a pen-up action. In between these two actions, the stylus can be moved about on the character-generating control matrix as desired (see the left-hand diagram of FIG. 12A), without affecting the accuracy of the mapping between a combination of selected control regions and its corresponding alphanumeric character. In cases where the character is represented by a single region, the pen-down and pen-up actions remain on a single region (see the right hand diagram of FIG. 12A). Other possible applications for the matrix-complement techniques described above include desktop computer systems, automated teller machines, and mobile telephone devices where the control regions are typically represented by spaced apart (rather than abutting) mechanical pushbuttons on a keyboard or keypad. In such an embodiment, one or more key activation events may be prescribed for each character. For example, one or more keys may be associated with a given character, and an activation event for each key may be defined as the key being depressed or let go by the user. Note that the timing of the activation events for a given combination may not matter, if the combination of events is based on a combination of keys that is unique to each character.

Sometimes the user may want to undo the effect of a region selection action for a certain character, prior to beginning the process of indicating the next character. According to an embodiment of the invention in which the PU and PD actions are used for such region selection, the undoing or reversing process may be described as follows. First, the user performs an initial PD action upon a first region. The system then detects the first region. Next, the user slides the stylus out of the first region, without any PU actions. Now, if the stylus is then slid back to the first region (without any PU actions), and is then followed by a PU action off the first region, the system interprets the sequence as not invoking a character. In other words, to undo his actions, the user slides the stylus back to the first region that was selected by the initial PD action, and then lifts the stylus, to prevent a character from being generated.

Special Characters

There are some characters that may be too complex to be easily represented using only a combination of regions from the complement matrix 408 (see FIGS. 4-7). There are also characters that look so similar to each other that a combination of selection regions assigned for one of them would also be suggested for the other. One solution for invoking these special characters, while using the same complement matrix defined above, is as follows. First, an association between a special character and a certain previously defined control region combination is made. For example, the character “@” looks like the letter “a” and hence may be associated with the same two-region combination assigned to “a”. Similarly, the characters “[” and “{” may be associated with the two-region combination that is assigned to the letter “c”. Alternatively, the character “{” can be associated with another similar looking special character, namely “<”. This is also referred to as control region sharing by different characters, which are assigned the same base or initial set of regions. Next, to distinguish between two similar characters (that share the same initial set of control regions or code configuration), a special control region, which may be separate from the complement matrix or the control matrix, is defined that may be selected by the user to indicate one, and not the other, of the two similar characters.

A preferred approach to distinguishing between two similar looking characters, however, is to define a special movement of the user's finger or stylus, during the region selection process. For example, in the touch-sensitive screen embodiment, which may also support PU and PD events, a “swirl” action can be defined as sliding the stylus on the surface of the screen. The motion may be clockwise or counterclockwise, while staying within a given control region and without lifting the stylus off the screen. See FIG. 12B. The initial direction of motion, clockwise or counterclockwise, may be used as a differentiating factor. The number of swirl orbits, or partial orbits, detected by the system may also be used as differentiating factors (see FIG. 12B which illustrates a single, clockwise orbit, while FIG. 12C shows one and a half, counterclockwise orbits). For example, the number of swirl orbits or partial orbits that have been detected may serve to increment or decrement a selection counter, where post-initial swirl direction determines the increment/decrement action, and each count is used to indicate a different special character. A swirl may also be used to indicate an additional control option (e.g., begin or stop capitalize, begin or stop bold face, insert a space, etc.).

The swirl may be applied in the final selection region of a given code configuration, to allow the user to cycle through viewing the initial character and then the different special characters that bear some resemblance to the initial character. Note that all of these special characters share the first and second selection regions, but can now be differentiated using the swirl action. Another way to explain this effect is to consider that several special characters can share the same code configuration of a base character, i.e., the same initial combination of one or more control regions to be selected that have been assigned to the base character, and the swirl action distinguishes beyond this initial code. For example, in FIG. 12D, the character “[” has been invoked by selecting the regions 1275 and 1277 (which, without more, represents a default code configuration, namely that of lower case “c”), followed by a single (1) swirl. Making an additional swirl (2) results in the character “{” being invoked (see FIG. 12E). To make the choices more clear, the corresponding graphic symbols or pictograms (which may be given additional detail as needed to resemble their corresponding characters) are superimposed onto the control matrix as shown. Note that stepping backwards and forward through the possible characters may be accomplished by reversing the direction of the swirl.

Additional Embodiments

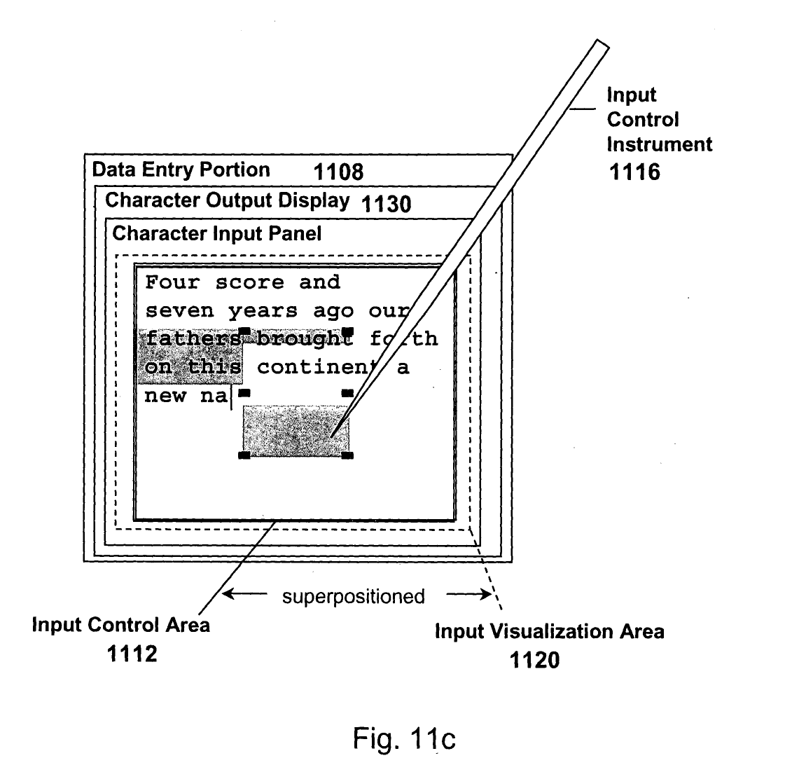

Turning now to FIG. 13A, another embodiment of the invention is illustrated as another set of graphic symbols that correspond to the 36 alphanumeric characters. In this embodiment, each receiving area 1304 is of a contrasting color with respect to its background 1306, with a peripheral boundary 1307 shown in a darker color. Each receiving area 1304 is to receive a combination of one or more marks that represents the desired alphanumeric character. Each mark has a given form, position, and orientation within the receiving area 1304, that suggest a feature of the character, once again through a complementary rather than direct relationship with that feature. Taking the letter “a” as an example, the receiving area 1304 for that letter bears a mark 1312 being a dot positioned in the lower half of the rectangular receiving area 1304, where the dot refers to the feature of a below-center closed curve 132 (see FIG. 1). The mark 1312 is also used for representing other characters such as “b” and “d” as shown.

A second mark 1310 is needed to define the graphic symbol for the letter “a” shown in FIG. 13A. The mark 1310 is a straight line that is pointing upwards and to the right, and is positioned in a left half of the receiving area 1304. This mark 1310 refers to the feature of an above-center curve opening to the left 139 (see FIG. 1). It can be seen that the combination of the marks 1310 and 1312, when viewed on the receiving area 1304 which is contrasted with its background 1306, suggests to a person that the receiving area 1304 is referring to the letter “a”. Note that the straight lines may alternatively be angled differently, slightly curved, or they may be substantially horizontal, and still be capable of visually depicting the letter “a”.

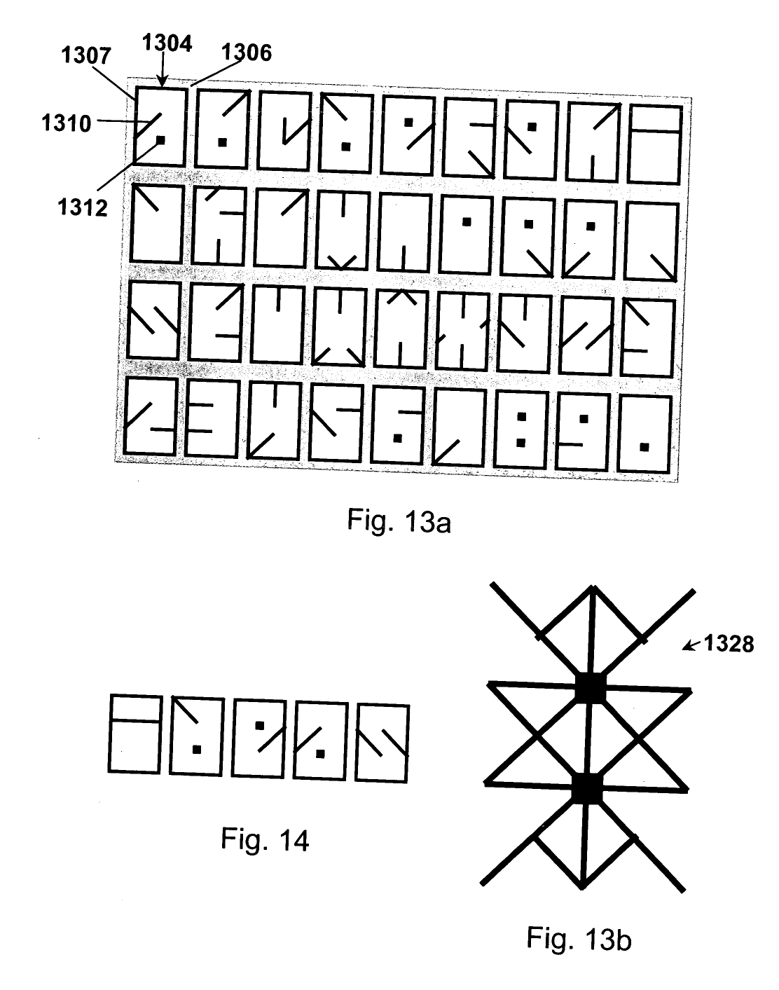

The inventor has found that a generic receiving area template or “matrix” 1328 with a rectangular shape (including top, middle, and bottom non-overlapping regions), as shown in FIG. 13B, may be used to represent each of the 36 alphanumeric characters, using a combination of only straight lines and dots (such as the marks 1310 and 1312). The matrix 1328 in FIG. 13B shows all of the possible marks in this embodiment, namely two dots and 18 straight lines, in various positions and orientations as shown. This embodiment of the invention may be more effective where the user is to indicate each character in a separate receiving area, as if a word were being written on a sheet of paper. The border 1307 (see FIG. 13A), and the contrasting colors of the receiving area 1304 and the background 1306 may be preprinted or pre-displayed on a form, and the user is then instructed to indicate the desired character by simply making the marks being a dot or a straight line. A word spelled using the graphic symbols of FIG. 13A is shown in FIG. 14. It is noted that when forming words and phrases based on the graphic symbols depicted in FIG. 13A, none of the marks that are to be made by the user to indicate the characters form a closed shape.

It is expected that the user can quickly learn the combination of dots and/or lines that represent each character, as shown in the embodiment of FIG. 13A, by recognizing or recalling the complement-matrix approach described above. The orientation and location of each dot and/or line for a given character is suggested by one or more features of the character, which should be apparent to the user. For example, if the user wants to enter the character “3”, the user should recall that this character can be decomposed into an upper curve opening to the left and a lower curve opening to the left, stacked. This will immediately suggest that two substantially horizontal lines, one substantially in the upper half and another substantially in the lower half, need to be marked, at the left side of the receiving area 1304, so that the resulting graphic symbol will resemble the number “3”.

To summarize some embodiments of the invention, a novel character representation or coding technique has been described that is easy to learn. Rather than have the user positively draw or define the features of a character, the user is instead instructed to positively indicate (or manually apply force) to those regions that are the complement of one or more features of the character. For example, rather than have the user draw the entire contour of a plane closed curve (as in the letter “o”), the user contacts a point in a control region that is understood as representing the inside of the plane closed curve. It is then up to the electronic device, or other mechanism, to reflect the visual contrast needed to highlight the actual features of the desired character, based on the complement selection (e.g. visually contrasting the entire control region relative to its surrounding control regions). Other embodiments have also been described and claimed.

In the foregoing specification, the invention has been described with reference to specific exemplary embodiments thereof. It will, however, be evident that various modifications and changes may be made thereto without departing from the broader spirit and scope of the invention as set forth in the appended claims. For example, although the invention has been described in the context of English alphanumeric characters, the complement approach may also be applied to encode the characters of other languages. The specification and drawings are, accordingly, to be regarded in an illustrative rather than a restrictive sense.

### APPENDIX A

I hereby appoint with full power of substitution and revocation, to prosecute this application and to transact all business in the Patent and Trademark Office connected herewith, BLAKELY SOKOLOFF TAYLOR & ZAFMAN LLP, a firm including: Ramin Aghevli, Reg. No. 43,462; William E. Alford, Reg. No. 37,764; Farzad E. Amini, Reg. No. 42,261; W. Thomas Babbitt, Reg. No. 39,591; Jordan M. Becker, Reg. No. 39,602; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Cory G. Claassen, Reg. No. 50,296; Thomas M. Coester, Reg. No. 39,637; Mimi D. Dao, Reg. No. 45,628; Stephen M. De Klerk, Reg. No. 46,503; Daniel M. De Vos, Reg. No. 37,813; Sanjeet Dutta, Reg. No. 46,145; Tarek N. Fahmi, Reg. No. 41,402; Thomas S. Ferrill, Reg. No. 42,532; George L. Fountain, Reg. No. 36,374; Adam Furst, Reg. No. 51,710; Angelo J. Gaz, Reg. No. 45,907; Andre M. Gibbs, Reg. No. 47,593; James Y. Go, Reg. No. 40,621; Jason R. Graff, Reg. No. 54,134; Jeffery Scott Heileson, Reg. No. 46,765; James A. Henry, Reg. No. 41,064; Willmore F. Holbrow III, Reg. No. 41,845; Sheryl Sue Holloway, Reg. No. 37,850; George W Hoover II, Reg. No. 32,992; Eric S. Hyman, Reg. No. 30,139; Aslam A. Jaffery, Reg. No. 51,841; Walter T. Kim, Reg. No. 42,731; Eric T. King, Reg. No. 44,188; Steven Laut, Reg. No. 47,736; Suk S. Lee, Reg. No. 47,745; Gordon R. Lindeen III, Reg. No. 33,192; Jan Carol Little, Reg. No. 41,181; Joseph Lutz, Reg. No. 43,765; Michael J. Mallie, Reg. No. 36,591; Andre L. Marais, Reg. No. 48,095; Raul D. Martinez, Reg. No. 46,904; Paul A. Mendonsa, Reg. No. 42,879; Jonathan S. Miller, Reg. No. 48,534; Heather M. Molleur, Reg. No. 50,432; Richard A. Nakashima, Reg. No. 42,023; Thinh V. Nguyen, Reg. No. 42,034; Robert B. O'Rourke, Reg. No. 46,972; Daniel E. Ovanezian, Reg. No. 41,236; Philip A. Pedigo, Reg. No. 52,107; Marina G. Portnova, Reg. No. 45,750; Joseph A. Pugh, Reg. No. 52,137; James H. Salter, Reg. No. 35,668; William W. Schaal, Reg. No. 39,018; James C. Scheller, Reg. No. 31,195; Saina S. Shamilov, Reg. No. 48,266; Kevin G. Shao, Reg. No. 45,095; Stanley W. Sokoloff, Reg. No. 25,128; Judith A. Szepesi, Reg. No. 39,393; Edwin H. Taylor, Reg. No. 25,129; Lisa Tom, Reg. No. 52,291; John F. Travis, Reg. No. 43,203; Kerry D. Tweet, Reg. No. 45,959; Mark C. Van Ness, Reg. No. 39,865; Thomas A. Van Zandt, Reg. No. 43,219; Mark R. Vatuone, Reg. No. 53,719; LesterJ. Vincent, Reg. No. 31,460; John P. Ward, Reg. No. 40,216; Mark L. Watson, Reg. No. 46,322; Thomas C. Webster, Reg. No. 46,154; Chui-Kiu Teresa Wong, Reg. No. 48,042; and Norman Zafman, Reg. No. 26,250, my patent attorneys, and Brent Vecchia, Reg. No. 48,011 and Lehua Wang, Reg. No. 48,023, my patent agents, with offices located at 12400 Wilshire Boulevard, 7th Floor, Los Angeles, Calif. 90025, telephone (310) 207-3800; and James R. Thein, Reg. No. 31,710, my patent attorney, with full power of substitution and revocation, to prosecute this application and to transact all business in the Patent and Trademark Office connected herewith.

1. A method for generating a desired alphanumeric character, comprising:
providing a plurality of mnemonic aids that represent a plurality of different alphanumeric characters, each aid being designed so that it can suggest to a person a respective combination of one or more zones, from a plurality of zones, wherein if the combination is contrasted with the remainder of said plurality of zones then the remainder resembles the desired character.

2. The method of claim 1 wherein said plurality of zones are arranged so that the periphery around them is the maximum extent of every graphic symbol that appears when a combination of one or more zones is contrasted.

3. The method of claim 1 wherein said plurality of zones form a matrix.

4. The method of claim 3 wherein the matrix has twelve zones arranged in four rows and three columns.

5. The method of claim 3 wherein the respective combination of zones has no more than two zones, and wherein the plurality of mnemonic aids represent all 26 letters of the English alphabet and 10 decimal numerals.

6. The method of claim 3 wherein each aid is depicted by a matrix of said plurality of zones that shows the respective combination.

7. The method of claim 1 further comprising visually contrasting a combination of one or more of said plurality of zones with unselected ones of said plurality of zones, as the combination is being selected by a person.

8. A method for generating alphanumeric characters, comprising: providing a plurality of selection zones;
instructing a user to select a combination, of one or more of said plurality of selection zones, that represents the user's desired alphanumeric character; and
providing a mapping between said selected combination and the desired alphanumeric character, wherein the mapping is based on a) representing each character as a juxtaposition of some of a plurality of open and closed curves, the plurality of selection zones being fewer than the plurality of curves, b) creating a template containing all of the plurality of open and closed curves, and c) aligning the template with the plurality of selection zones.

9. The method of claim 8 further comprising:
enabling the user to select one of the selection zones in the combination, by one of a) depressing a respective push-button and b) touching a respective region in a touch-sensitive surface.

10. A method for textual communication, comprising:
forming words and phrases using some of a plurality of graphic symbols that represent an entire alphabet, wherein each graphic symbol visually suggests a separate letter of the alphabet and is made of one or more marks, in a receiving area, none of which form a closed shape.

11. The method of claim 10 wherein a word is formed by a user marking a separate receiving area for each graphic symbol that constitutes the word as if the user were writing the word on a sheet of paper.

12. The method of claim 11 wherein the user is using a writing instrument to mark a form sheet on which a plurality of separate receiving areas have been delineated.

13. A method for textual communication, comprising:
considering a receiving area that bears a combination of one or more marks as representing an alphanumeric character, wherein each mark has a given form, position and orientation, within the receiving area, that suggest a feature of the character through a complementary rather than direct relationship with that feature.

14. The method of claim 13 further comprising considering a plurality of said combinations as constituting a word, wherein each of said plurality of combinations is located in a separate receiving area, as if the word were written on a sheet of paper.

15. The method of claim 13 wherein the receiving area is rectangular and has upper and lower non-overlapping regions, and said one or marks are from the group consisting of straight lines and dots.

16. The method of claim 15 wherein a dot positioned in the lower region of the rectangle refers to the feature of a closed curve, as in the characters “a”, “b”, and “d”.

17. The method of claim 15 wherein a dot positioned in the upper region of the rectangle refers to the feature of a closed curve, as in the characters “e”, “g”, “p” and “q”.

18. The method of claim 15 wherein a vertical straight line positioned in the upper region refers to the feature of a curve opening upwards, as in the characters “M”, “U”, “V”, “X”, and “Y”.

19. The method of claim 15 wherein a straight line that is positioned in the lower region to the right refers to the feature of a curve opening to the right, as in the character “e”.

20. The method of claim 15 wherein a straight line that is positioned in the lower region to the left refers to the feature of a curve opening to the left, as in the character “g”.

21. An article of manufacture comprising:
a machine-readable medium having data stored therein that, when accessed by a processor, maps each of a plurality of alphanumeric characters to a respective selection of one or more regions from a plurality of regions so that if the respective selection of regions were to be contrasted with the remainder of the plurality of regions, then said remainder would positively define a plurality of features of a respective one of the alphanumeric characters.

22. The article of manufacture of claim 21 wherein the data is designed to allow said respective selection to be made via touch-sensitive screen inputs.

23. The article of manufacture of claim 21 wherein the medium has further data that, when accessed by the processor, divides a display surface of a touch-sensitive screen device into a two-dimensional matrix of said plurality of regions, and allows said respective selection to be made via input events on the display surface.

24. The article of manufacture of claim 23 wherein the medium has further data that, when accessed by the processor, displays a graphic symbol on the display surface that is aligned with the two-dimensional matrix, wherein the graphic symbol represents an alphanumeric character that has been mapped to said respective selection, so that a user can immediately confirm whether her selection resulted in the alphanumeric character she had intended to be retrieved.

25. The article of manufacture of claim 24 wherein the data is to display the graphic symbol by contrasting the selected regions with the remainder of the plurality of regions in said matrix, so that the graphic symbol as displayed is substantially coextensive with the outside boundary of said matrix and at least a part of every contrast area that allows the symbol to be viewed falls within a corresponding region that has been selected.

26. The article of manufacture of claim 25 wherein the data is to display the graphic symbol using a visualization area of the display surface that has higher resolution than said matrix, so that the symbol more closely resembles the alphanumeric character.

27. The article of manufacture of claim 21 wherein the data is to treat the respective selection as one for which said remainder positively defines a closed plane curve located below a left opening plane curve, as in [symbol]
which features belong to the character “a”, the respective selection having a first selected region located in a lower half of an arrangement of said plurality of regions and a second selected region located to the left and above the first region in said arrangement.

28. The article of manufacture claim 21 wherein the data is to treat the respective selection as one for which said remainder positively defines a closed plane curve located above a right opening plane curve, as in [symbol]
which features belong to the character “e”, the respective selection having a first selected region located in a upper half of an arrangement of said plurality of regions and a second selected region located to the right and below the first region in said arrangement.

29. An electronic system comprising:
a touch-sensitive display screen;
logic that implements an association between each of a plurality of alphanumeric characters and a respective combination of one or more regions selected from a matrix of regions that have been defined on the display screen, so that if the respective combination were to be visually contrasted with the remainder of the matrix then said remainder would resemble one of the alphanumeric characters; and
a power source coupled to power the display screen and said logic.

30. The system of claim 29 wherein the regions of a given combination, that is associated with a desired character, are those which are suggested by one or more features of the desired character.

31. The system of claim 30 wherein the matrix is taller than it is wide, the desired character is “a” whose features include a closed plane curve located below a left-opening plane curve, as in [symbol]
and there are two regions in the given combination associated with “a”, the first region being located in a lower half of the matrix and the second region being located to the left and above the first region.

32. The system of claim 30 wherein the desired character is “p” whose features include a closed plane curve located above an upside-down “L”, as in [symbol]
and there are two regions in the given combination associated with “p”, the first region being located in an upper half of the matrix, and the second region being located to the right and below the first region.

33. The system of claim 26 further comprising logic that is to control the touch-sensitive display screen so that the respective combination is visually contrasted with the remainder of the matrix as an operator selects the combination, to produce a sensation in the operator of drawing the desired character.

34. A computing device comprising:
a data entry user interface;
an input control instrument;
said data entry user interface comprising a character output display area and an input control panel area, said input control panel area including a region responsive to said input control instrument;
a microprocessor;
a data storage device in communication with and addressable by said microprocessor;
data defining a set of character input signals derived from the features of a system of stylized alphanumeric character glyphs, and data for forming visual representations of alphanumeric characters, being stored within said data storage device;
an input control matrix defined within said region of said input control panel area said input control matrix being switchable between a plurality of configurations, wherein each of a predetermined plurality of said configurations corresponds to one of said character input signals;
an input visualization area defined within said region of said input control panel area, the input visualization area and the input control matrix being positioned relative to each other so that one lies over the other with like parts coinciding;
said input visualization area comprising a plurality of sections, each of said sections being characterized by visually-contrasting first and second states, said input control matrix, in response to said input control instrument, to define an input signal describing a selected configuration of said input control matrix; and
said microprocessor to receive said input signal, interrogate said storage device for a corresponding alphanumeric character, to form a pictogram of a corresponding stylized alphanumeric character glyph on said input visualization area, aligned with the selected configuration, and to transmit an output signal for said corresponding alphanumeric character to said character output display area of said data entry user interface.

35. A device as defined in claim 34 wherein said input control instrument is a stylus.

36. A device as defined in claim 34 wherein said input control matrix comprises a two-dimensional array of cells.

37. A device as defined in claim 34 further characterized in that:
a) a glyph formation matrix is programmed into said device;
b) said glyph formation matrix defining a two-dimensional array of sections; and
c) said data defining a set of stylized alphanumeric character glyphs identifying preselected sections of said glyph formation matrix.

38. A method for inputting alphanumeric characters onto a data entry user interface, said method comprising:
a) providing a glyph formation matrix comprising a two-dimensional arrangement of regions in the data entry user interface for displaying a set of alphanumeric character glyphs;
b) providing an input control matrix, comprising a two-dimensional arrangement of cells in the data entry user interface, being coextensive with and aligned with said glyph formation matrix;
c) establishing a correspondence between a configuration of said input control matrix, defined by a combination of one or more selected cells within said input control matrix, and an alphanumeric character glyph;
d) receiving a selected configuration of said input control matrix; then
e) identifying a corresponding alphanumeric character; and then
f) displaying an alphanumeric character glyph that corresponds to said selected configuration of said input control matrix, by contrasting one or more selected ones of said regions with said glyph formation matrix.

39. A method as defined in claim 38 wherein the configuration was selected by a user addressing at least one cell of said input control matrix by means of a stylus.

40. A method defined in claim 39 wherein the searching for the corresponding alphanumeric character further includes applying an input signal to a microprocessor defining said selected input control matrix configuration; then
b) interrogating a data storage device for an alphanumeric character corresponding to said selected input control matrix configuration; then
c) recalling data from a data storage device defining preselected regions of said glyph formation matrix for representing said corresponding alphanumeric character; and then
d) providing said data in an output signal to a input visualization area of said data entry user interface.

41. A method comprising:
providing a plurality of zones; and
contrasting a combination of one or more of the plurality of zones with a remainder of the plurality of zones, the combination having been selected by a user to represent a desired alphanumeric character, wherein the plurality of zones and the combination are such that, when contrasted, the remainder resembles the desired character.

42. A method comprising:
providing a plurality of zones; and
contrasting a combination of one ore more of the plurality of zones with a remainder of the plurality of zones, the combination having been selected by a user to represent a desired alphanumeric character, wherein the plurality of zones and the combination are such that the remainder forms one or more positive features of the desired character.
